(19) United States
(12) Patent Application Publication
(10) Pub. No.: US 2017/0364838 A1
(43) Pub. Date: Dec. 21, 2017

(54) SERVICE VOUCHER PROCESSING METHOD, DEVICE, AND SYSTEM, AND STORAGE MEDIUM

(71) Applicant: Tencent Technology (Shenzhen) Company Limited, Shenzhen (CN)

(72) Inventors: Jianjun ZHANG, Shenzhen (CN); Chunguang HAN, Shenzhen (CN); Tao XIANG, Shenzhen (CN)

(73) Assignee: Tencent Technology (Shenzhen) Company Limited, Shenzhen (CN)

(21) Appl. No.: 15/676,674

(22) Filed: Aug. 14, 2017

Related U.S. Application Data
(63) Continuation of application No. PCT/CN2016/084585, filed on Jun. 2, 2016.

(30) Foreign Application Priority Data
Dec. 8, 2015 (CN) 201510896347.3

(51) Int. Cl. G06Q 10/02; H04L 29/06; G06Q 50/30

(52) U.S. Cl. CPC G06Q 10/02; H04L 63/102; G06Q 50/30

(57) ABSTRACT

A service voucher processing method, device, and system, and a storage medium are disclosed. The method includes: obtaining information about a candidate service, and loading a virtual identifier of the candidate service in a graphical interface; initiating, if a target service reserved by the reservation instruction is detected, a reservation request; obtaining a service voucher corresponding to the target service based on permission corresponding to the target service, and activating the service voucher when an instruction for using the target service is detected; performing authentication on the permission, a verification request carrying permission information, and a serial communication method being used for the verification request; and providing the permission when the authentication passes, determining that the target service is used, and cancelling the permission. The present disclosure can support, in a high-efficient and convenient manner, a user to use services such as taking a bus/metro/train or the like.

### RELATED APPLICATION

This application is a continuation application of PCT Patent Application No. PCT/CN2016/084585, filed on Jun. 2, 2016, which claims priority to Chinese Patent Application No. 201510896347.3, filed with the Chinese Patent Office on Dec. 8, 2015, both of which are incorporated herein by reference in their entireties.

### FIELD OF THE TECHNOLOGY

The present invention relates to the communications field, and in particular, to a service voucher processing method, device, and system, and a storage medium.

### BACKGROUND OF THE DISCLOSURE

As important parts of the public transportation industry, buses, metros, and high-speed railways have large passenger flows, are used frequently, and have small consumption amounts per transaction. When purchasing tickets, passengers face many problems. For example, it is hard to obtain change, the tickets are inconvenient to keep and carry, banknotes are subject to degradation and are difficult to identify correctly by machines, and there is a slow speed. In a passenger flow peak, it is very common to have long queues in front of ticket vending machines (TVMs, Ticket Vending Machines) in order to purchase tickets, thereby affecting efficiency of purchasing tickets.

Currently, various integrated circuit (IC, Integrated Circuit) cards containing security chips, radio frequency identification (RFID, Radio Frequency Identification) cards containing security chips, near field communication (NFC) modules, or single wire protocol (SWP, Single Wire Protocol)-subscriber identity module (SIM, Subscriber Identity Module) cards are often used for simulating IC cards as service vouchers for taking a bus/metro/train or the like, and there are at least the following problems:
1) an additional security card is required to store offline account information, and there is high cost;
2) there is bad interconnectivity; different IC cards need to be purchased in different cities, thereby increasing additional cost; and
3) online recharging cannot be implemented, and recharging can be implemented at particular places; encashment is hard to be implemented when a card is no longer used, and the card is inconvenient to be used.

### SUMMARY

Embodiments of the present invention provide a service voucher processing method, device, and system, and a storage medium, so as to support, in a high-efficient and convenient manner, a user to use services such as taking a bus/metro/train or the like.

Technical solutions of the embodiments of the present invention are implemented in this way.

According to a first aspect, an embodiment of the present invention provides a service voucher processing method, the service voucher processing method including:
obtaining, by a client device comprising a first memory and a first processor in communication with the first memory, information about a candidate service, loading a virtual identifier of the candidate service in a graphical interface based on the information about the candidate service, and detecting a reservation instruction for the candidate service based on the virtual identifier;
initiating, by the client device, when a target service reserved by the reservation instruction in the candidate service is detected, a reservation request for the target service, so as to trigger a service reservation device to assign permission corresponding to the target service, the service reservation device comprising a second memory and a second processor in communication with the second memory;
obtaining, by the client device, a service voucher corresponding to the target service based on the permission corresponding to the target service;
activating, by the client device, the service voucher of the target service when an instruction for using the target service is detected;
performing, by a service voucher device comprising a third memory and a third processor in communication with the third memory, based on the activated service voucher, authentication on the permission for using the target service, a verification request carrying permission information being initiated in an authentication process, and a serial communication method being used for the verification request; and
providing, by the service voucher device, the permission of the target service if it is determined that the authentication passes, determining that the target service is used, and cancelling the permission of the target service.

According to a second aspect, an embodiment of the present invention provides a service voucher processing system, the service voucher processing system including:
a service reservation device, configured to assign permission corresponding to a target service detected by a client device, wherein the client device is configured to:
   obtain information about a candidate service,
   load a virtual identifier of the candidate service in a graphical interface based on the information about the candidate service,
   detect a reservation instruction for the candidate service based on the virtual identifier,
   when the target service reserved by the reservation instruction in the candidate service is detected, initiate a reservation request for the target service,
   obtain a service voucher corresponding to the target service based on the permission corresponding to the target service, and
   when an instruction for using the target service is detected, activate the service voucher of the target service; and
a service voucher device, configured to:
   perform, based on the activated service voucher, authentication on the permission corresponding to the target service,
   when it is determined that the authentication passes, provide the permission corresponding to the target service,
   when it is determined that the target service is used, cancel the permission corresponding to the target service, and
   wherein a verification request carrying permission information of the target service is initiated in an authentication process and a serial communication method is used for the verification request.

According to a third aspect, an embodiment of the present invention provides a service voucher processing method, applied to a client, the service voucher processing method including:
obtaining, by a client device comprising a memory and a processor in communication with the memory, information about a candidate service, loading a virtual identifier of the candidate service in a graphical interface based on the information about the candidate service, and detecting a reservation instruction for the candidate service based on the virtual identifier;
initiating, by the client device, when a target service reserved by the reservation instruction in the candidate service is detected, a reservation request for the target service, so as to obtain permission corresponding to the target service; and
obtaining, by the client device, a service voucher corresponding to the target service based on the permission corresponding to the target service, and activating the service voucher of the target service when an instruction for using the target service is detected, the service voucher being used for triggering a process of authenticating the permission for using the target service, so as to provide the permission of the target service when the authentication passes, and a serial communication method being used for a verification request that carries permission information and that is initiated in the authentication process.

According to a fourth aspect, an embodiment of the present invention provides a service voucher processing method, applied to a service reservation device, the service voucher processing method including:
assigning, by a service reservation device comprising a first memory and a first processor in communication with the first memory, permission of a target service reserved by a corresponding client by using a reservation request;
performing, based on a detected activated service voucher by a service voucher device comprising a second memory and a second processor in communication with the second memory, authentication on the permission for using the target service; and
providing, by the service voucher device, the permission of the target service when it is determined that the authentication passes, determining that the target service is used, and cancelling the permission of the target service, a verification request carrying permission information being initiated in an authentication process, and a serial communication method being used for the verification request.

According to a fifth aspect, an embodiment of the present invention provides a client device, the client device including:
a memory storing instructions;
a processor in communication with the memory, wherein, when the processor executes the instructions, the processor is configured to cause the client device to:
   obtain information about a candidate service, load a virtual identifier of the candidate service in a graphical interface based on the information about the candidate service, and detect a reservation instruction for the candidate service based on the virtual identifier;
   initiate, if a target service reserved by the reservation instruction in the candidate service is detected, a reservation request for the target service, so as to obtain permission corresponding to the target service; and
   obtain a service voucher corresponding to the target service based on the permission corresponding to the target service, and activate the service voucher of the target service if an instruction for using the target service is detected, the service voucher being used for triggering a process of authenticating the permission for using the target service, so as to provide the permission of the target service when the authentication passes, and a serial communication method being used for a verification request that carries permission information and that is initiated in the authentication process.

According to a sixth aspect, an embodiment of the present invention provides a service voucher device, the service voucher device including:
a memory storing instructions;
a processor in communication with the memory, wherein, when the processor executes the instructions, the processor is configured to cause the service voucher device to:
   assign permission of a target service reserved by a corresponding client by using a reservation request; and
   perform, based on a detected activated service voucher, authentication on the permission for using the target service;
   provide the permission of the target service when it is determined that the authentication passes, determine that the target service is used, and cancel the permission of the target service, a verification request carrying permission information being initiated in an authentication process, and a serial communication method being used for the verification request.

According to a seventh aspect, an embodiment of the present invention provides a non-transitory computer readable storage medium storing computer readable instructions, the computer readable instructions, when executed by a processor, causing the processor to perform:
obtaining information about a candidate service, loading a virtual identifier of the candidate service in a graphical interface based on the information about the candidate service, and detecting a reservation instruction for the candidate service based on the virtual identifier;
initiating, when a target service reserved by the reservation instruction in the candidate service is detected, a reservation request for the target service, so as to trigger to assign permission corresponding to the target service;
obtaining a service voucher corresponding to the target service based on the permission corresponding to the target service;
activating the service voucher of the target service when an instruction for using the target service is detected;
performing, based on the activated service voucher, authentication on the permission for using the target service, a verification request carrying permission information being initiated in an authentication process, and a serial communication method being used for the verification request; and
providing the permission of the target service if it is determined that the authentication passes, determining that the target service is used, and cancelling the permission of the target service.

According to an eighth aspect, an embodiment of the present invention provides a non-transitory computer readable storage medium storing computer readable instructions, the computer readable instructions, when executed by a processor, causing the processor to perform:
obtaining information about a candidate service, loading a virtual identifier of the candidate service in a graphical interface based on the information about the candidate service, and detecting a reservation instruction for the candidate service based on the virtual identifier;
initiating, when a target service reserved by the reservation instruction in the candidate service is detected, a reservation request for the target service, so as to obtain permission corresponding to the target service; and
obtaining a service voucher corresponding to the target service based on the permission corresponding to the target service, and activating the service voucher of the target service when an instruction for using the target service is detected, the service voucher being used for triggering a process of authenticating the permission for using the target service, so as to provide the permission of the target service when the authentication passes, and a serial communication method being used for a verification request that carries permission information and that is initiated in the authentication process.

According to a ninth aspect, an embodiment of the present invention provides a non-transitory computer readable storage medium storing computer readable instructions, the computer readable instructions, when executed by a processor, causing the processor to perform:
assigning permission of a target service reserved by a corresponding client by using a reservation request;
performing, based on a detected activated service voucher, authentication on the permission for using the target service; and
providing the permission of the target service when it is determined that the authentication passes, determining that the target service is used, and cancelling the permission of the target service, a verification request carrying permission information being initiated in an authentication process, and a serial communication method being used for the verification request.

In the embodiments of the present invention, when a user needs to use a target service, the user initiates a reservation request for the target service to a service reservation device client by using a client device (during actual implementation, the reservation request may be sent after payment for the target service is completed), so that a service voucher required for using the target service may be assigned to a service reservation system (the service voucher is different from an IC card; for example, the service voucher may be in a form of an image such as a two-dimensional code, thereby saving cost of setting the IC card in the client). That is, based on a service voucher processing system, for the user, as long as the client of the user has a communications capability (such as cellular communication or WiFi communication) and can send the reservation request to the service reservation device, the client may obtain, in any time at any place according to own requirements, a service voucher of a service (a target service) required to be used, and use the service based on the service voucher without implementing an IC card in the client and without prepaying.

### BRIEF DESCRIPTION OF THE DRAWINGS

FIG. 1 is a schematic structural diagram 1 of a service voucher processing system according to an embodiment of the present invention;

FIG. 2 is a schematic flowchart 1 of a service voucher processing method according to an embodiment of the present invention;

FIG. 3 is a schematic flowchart 2 of a service voucher processing system according to an embodiment of the present invention;

FIG. 4 is a schematic structural diagram 2 of a service voucher processing system according to an embodiment of the present invention.

FIG. 5 is a schematic flowchart 3 of a service voucher processing system according to an embodiment of the present invention;

FIG. 6 is a schematic structural diagram 3 of a service voucher processing system according to an embodiment of the present invention;

FIG. 7 is a schematic flowchart 4 of a service voucher processing system according to an embodiment of the present invention;

FIG. 8 is a schematic flowchart 5 of a service voucher processing system according to an embodiment of the present invention;

FIG. 9 is a schematic flowchart 6 of a service voucher processing system according to an embodiment of the present invention;

FIG. 10 is a schematic diagram of a payment screen for a target service in a client according to an embodiment of the present invention;

FIG. 11A to FIG. 11C are schematic diagrams of scenarios for processing a service voucher according to an embodiment of the present invention;

FIG. 12 is a schematic structural diagram of an online ticket fetching machine according to an embodiment of the present invention; and

FIG. 13 is a schematic structural diagram of processing online ticketing according to an embodiment of the present invention.

### DESCRIPTION OF EMBODIMENTS

The present invention is further described below in detail with reference to the accompany drawings and embodiments. It should be understood that the specific embodiments described herein are merely used for explaining the present disclosure, and are not used for limiting the present disclosure.

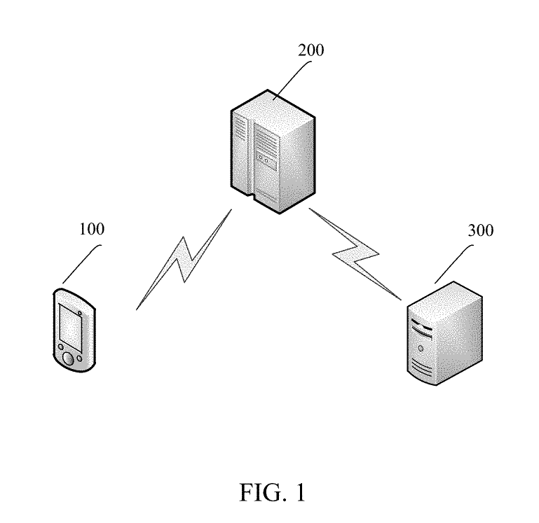

In the embodiments of the present invention, referring to an optional schematic structural diagram of a service voucher processing system shown in FIG. 1, the service voucher processing system shown in FIG. 1 includes a service reservation end device 200 (a service reservation device 200 for short), a client device 100 (a client 100 for short), a service voucher end device 300 (a service voucher device 300 for short).

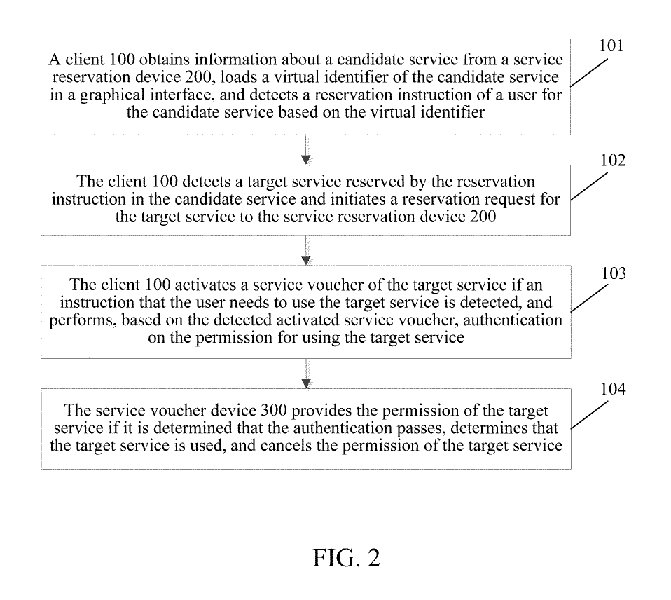

Referring to an optional schematic flowchart of a service voucher processing method shown in FIG. 2, in step 101, the client device 100 obtains information about a candidate service from the service reservation device 200, loads a virtual identifier of the candidate service in a graphical interface, and detects a reservation instruction of a user for the candidate service based on the virtual identifier. In step 102, the client device 100 detects a target service reserved by the reservation instruction in the candidate service and initiates a reservation request for the target service to the service reservation device 200, to enable the service reservation device 200 to assign permission corresponding to the target service, so that the client device 100 obtains a service voucher corresponding to the target service based on the permission corresponding to the target service. When the user needs to use the reserved target service, correspondingly, in step 103, the client device 100 activates the service voucher of the target service if an instruction that the user needs to use the target service is detected, and performs, based on the detected activated service voucher, authentication on the permission for using the target service. In step 104, the service voucher device 300 provides the permission of the target service if it is determined that the authentication passes, determines that the target service is used, and cancels the permission of the target service.

The service may be of various forms, for example, public traffic services such as metros, buses, or civil flights, a takeout service, a cleaning service, a housekeeping service, an express service, or the like. In addition to the foregoing services in entity forms, the service may be a service in a virtual form such as network games, virtual social networking, or the like. The service may be a service in a form of online ordering and home implementing (that is, a service combining an entity form and a virtual form), for example, an online shopping and home delivery service or an online meal ordering and home delivery service.

In FIG. 1 and FIG. 2, when the user needs to use the target service, the user initiates the reservation request for the target service to the service reservation device 200 by using the client device 100 (during actual implementation, the reservation request may be sent after payment for the target service is completed), so as to enable the service reservation device 200 to assign the service voucher required for using the target service (the service voucher is different from an IC card; for example, the service voucher may be in a form of an image such as a two-dimensional code or another electronic voucher, thereby saving cost of setting the IC card in the client device 100). That is, based on the service voucher processing system shown in FIG. 1, for the user, as long as the client device 100 of the user has a communications capability (such as cellular communication or WiFi communication) and can send the reservation request to the service reservation device 200, the client device 100 may obtain, in any time at any place according to own requirements, a service voucher of a service (a target service) required to be used, and use the service based on the service voucher without implementing by setting an IC card in the client device 100 or by simulating in another form, and prepaying is not required, thereby facilitating the user to flexibly use money.

Descriptions are provided below with reference to specific embodiments.

### Embodiment 1

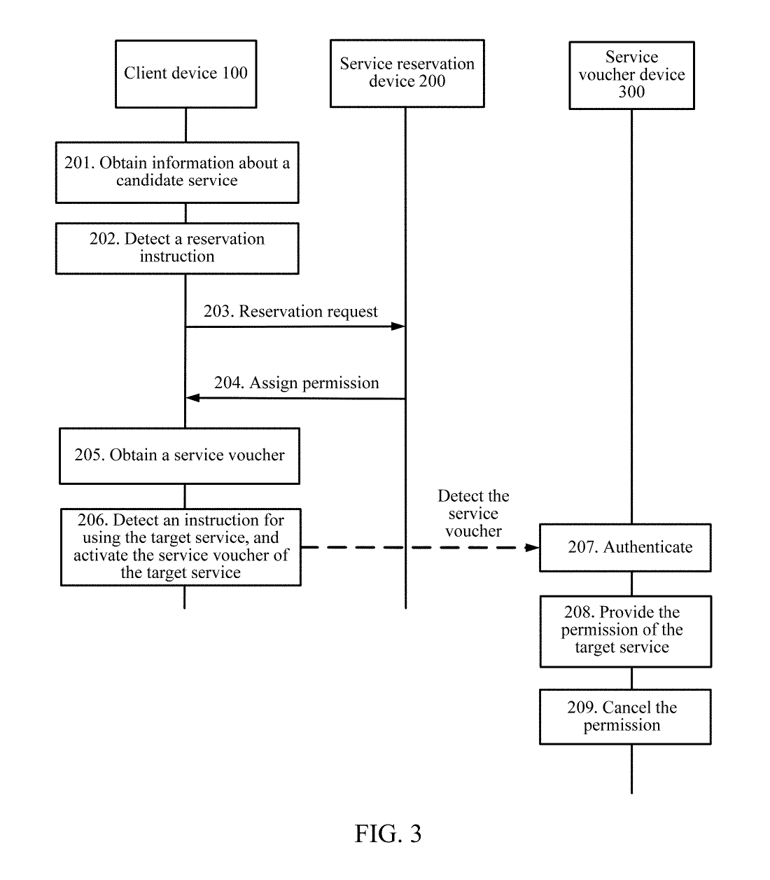

Referring to FIG. 3, a service voucher processing method disclosed in this embodiment includes the following steps:

Step 201: A client device 100 obtains information about one or more candidate services and loads a virtual identifier for each of the one or more candidate services in a graphical interface.

The candidate service is a service provided by a service provider for a user to select and use. The service may be divided into a service in an entity form, a service in a virtual form, and a service in a form of combining the entity form and the virtual form. Different services are often provided by different service providers. A service reservation device 200 is connected to backgrounds of the service providers to synchronize information about services provided by the service providers to the service reservation device 200 locally. According to different services provided by the service providers, information about the services provided by the service providers includes a plurality of aspects, for example, distribution areas, prices, and description information, and the like. The client device 100 loads virtual identifiers for different services (that is, candidate services) on the graphical interface. Different virtual identifiers display information about their corresponding services, respectively, so as to facilitate the user to select a service (that is, a target service), in the candidate services based on the virtual identifiers.

An example in which the user expects to use a metro-taking service is used. The user operates the client device 100 to obtain information about the metro-taking service such as stations of different lines, prices of the lines, and the like. The client device 100 requests the service reservation device 200 for information about the metro-taking service, and loads the information about the service provided by a metro operator in the graphical interface of the client device 100. The user selects a target service based on information such as a hoped to-be-taken line, a departure station, and an arrival station.

The service reservation device 200 may obtain, from the backgrounds of the service providers in advance, the information about services provided by the service providers and store the information to the service reservation device 200 locally. For example, the service reservation device 200 may obtain information about different lines from metro operators and civil flight operators in advance and store the information to the service reservation device 200 locally. When the client device 100 requests the service reservation device 200 for information about a candidate service (such as a metro service), the information about the candidate service may be directly returned to the client device 100, so as to reduce a time delay of loading the information about the candidate service by the client device 100. Certainly, the service reservation device 200 may obtain the information about the candidate service from a background of a corresponding service provider when receiving a reservation request sent by the client device 100, so as to ensure correctness of the provided information about the candidate service.

Generally, when a service provided by a service provider does not change frequently, for example, for metro lines operated by the metro operator. Occasional situations (such as line faults) are excluded since these situations are rare. Since operation time and departure frequencies of the metro lines are relatively fixed to a schedule, the service reservation device 200 may periodically synchronize line information of the metro operator to the service reservation device 200 locally. When a service by a service provider changes frequently, for example, for a takeout service of a restaurant, menus and prices may change every day, the service reservation device 200 obtains the information about the candidate service from the background of the service provider when receiving a reservation request sent by the client device 100.

Step 202: The client device 100 detects a reservation instruction for one of the one or more candidate services based on the virtual identifier.

A user learns about different services based on the virtual identifier loaded in the graphical interface and information of a corresponding service carried in the virtual identifier. When a service is determined, operations (such as a tapping operation) of particular forms are implemented on the virtual identifier for a target service in the graphical interface. Therefore, the client device 100 detects a tapping event in the graphical interface, analyzes, by positioning the tapping event on the graphical interface, the virtual identifier triggered by the user, and uses a service corresponding to the triggered virtual identifier as a target service, the tapping event triggering a reservation instruction of the target service. In addition, the virtual identifier may be used for the user to set information about details of the target service, for example, time required for using the service, places required for using the service, and the like.

Step 203: The client device 100 detects a target service reserved by the reservation instruction in the one or more candidate services and initiates a reservation request for the target service to a service reservation device 200 by using a communications network (such as the internet).

The reservation request carries information about the target service, and carries at least information for a service provider to correctly provide the service. For example, when the target service is a metro-taking service, the reservation request carries at least a name (or an identifier) of a metro line, information of a departure station, and information of an arrival station.

Step 204: The service reservation device 200 assigns permission corresponding to the target service.

Step 205: The client device 100 obtains a service voucher corresponding to the target service based on the permission corresponding to the target service.

The service voucher may be correspondingly generated by the service reservation device 200 based on the permission assigned to the client device 100, or may be generated by the client device 100 based on the assigned permission corresponding to the target service.

As an optional implementation, the service voucher may be generated by the client device 100 or the service reservation device 200 by using the following steps:

Step 2051: Obtain permission information of the target service and first signature information corresponding to the permission information, the first signature information being obtained by encrypting an abstract of the permission information by using a public key of an asymmetric encryption algorithm, and the permission information including at least an identifier of the reservation request.

The reservation request may further include a quantity of target services reserved by the reservation request, entirety cost information of the reserved target services requested by the reservation request, and the like. For example, when the target service is taking a metro, the reservation request may include a line (or a plurality of lines) required to be taken by a user, a departure station and an arrival station of the line taken by the user, and fees for taking the metro. For another example, when the target service is a takeout service, the reservation request includes a name of a reserved dish, a receiving address of the user, and the like.

Step 2052: Encode the permission information and the first signature information corresponding to the permission information to obtain a service voucher in at least one of the following forms:
1) an image, for example, an image obtained from encoding by using a two-dimensional code encoding algorithm or a barcode encoding algorithm, the image carrying the permission information and the first signature information corresponding to the permission information;
2) an acoustic signal, for example, an acoustic wave signal (such as an ultrasonic signal) obtained by encoding the permission information and the first signature information corresponding to the permission information in a particular manner, the ultrasonic signal carrying the permission information and the first signature information corresponding to the permission information;
3) an optical signal, for example, an optical wave signal (such as an infrared signal) obtained by encoding and modulating the permission information and the first signature information corresponding to the permission information by using an optical wave encoding algorithm, the optical wave signal carrying the permission information and the first signature information corresponding to the permission information; or
4) a radio frequency signal, that is, a radio frequency signal obtained by encoding and modulating the permission information and the first signature information corresponding to the permission information in a particular manner, the radio frequency signal carrying the permission information and the first signature information corresponding to the permission information.

Step 206: The client device 100 detects an instruction for using the target service, and activates the service voucher of the target service.

The user obtains the service voucher of the target service by using the client device 100, and the client device 100 locally stores data of the service voucher. When the user needs to use the target service, the user operates the client device 100 to activate the service voucher for the target service.

As an optional implementation, according to different forms of the service voucher, activation is implemented by using the following methods:
1) when the service voucher is in an image form, the client device 100 loads an image an image obtained from encoding by using a two-dimensional code encoding algorithm or a barcode encoding algorithm on the graphical interface, the image carrying permission information and first signature information corresponding to the permission information;
2) when the service voucher is in a form of an acoustic signal, the client device 100 sends an acoustic wave signal based on a built-in sounding apparatus, the acoustic wave signal carrying permission information and first signature information corresponding to the permission information;
3) when the service voucher is in a form of an optical signal, the client device 100 sends an optical signal based on a built-in light-emitting apparatus, the optical signal carrying permission information and first signature information corresponding to the permission information; and
4) when the service voucher is in a form of a radio frequency signal, the client device 100 sends a radio frequency signal based on a built-in radio frequency signal generation apparatus, the radio frequency signal carrying permission information and first signature information corresponding to the permission information.

Step 207: A service voucher device 300 performs, based on the detected activated service voucher, authentication on the permission for using the target service.

The service voucher device 300 compares the permission information (including an identifier of the reservation request, or permission check information in other forms) carried in the activated service voucher with the permission information corresponding to the permission assigned to the service reservation device 200. If the permission information carried in the activated service voucher and the permission information corresponding to the permission assigned to the service reservation device 200 are consistent, it indicates that the authentication on the permission of the target service passes.

Step 208: The service voucher device 300 provides the permission of the target service when determining that the authentication passes.

For example, when the service voucher device 300 is set in a passage gate of a metro, a gate door is open to allow users to pass; when the service voucher device 300 is set in a smart ticket checking machine in a scenic spot or a charging place (such as a scenic spot or a museum), users are allowed to enter.

Step 209: The service voucher device 300 determines that the target service is used and cancels the permission of the target service.

The service voucher device 300 determines a quantity of used permission of the target service, and sends information (including the identifier of a corresponding reservation request) of the used permission to the service reservation device 200, so that the service reservation device 200 cancels information of the assigned permission, thereby avoiding repeatedly assigning permission.

### Embodiment 2

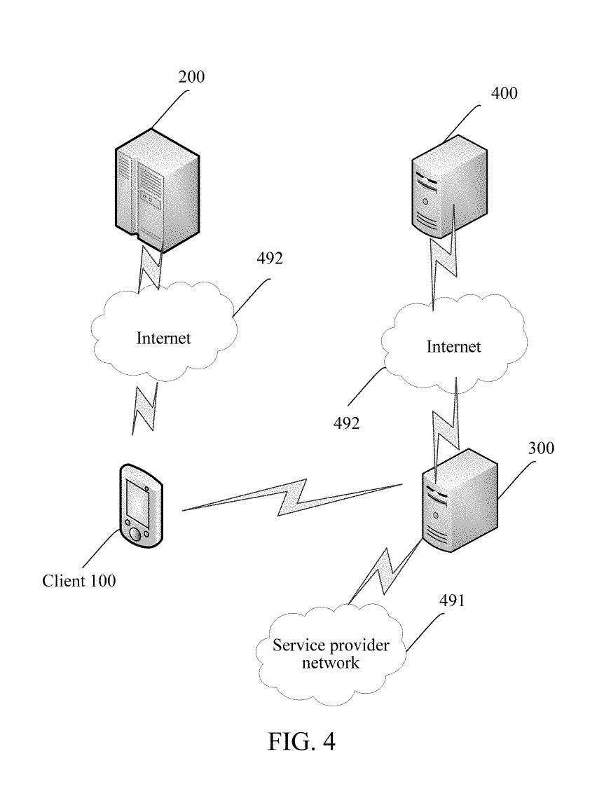

Referring to FIG. 4, based on a service voucher processing system shown in FIG. 1, the service voucher processing system may further include a service voucher check end device 400 (or a service voucher check device 400 for short), configured to perform authentication on permission for using a target service, and the client device 100 communicates with a service reservation device 200 by using a communications network (such as the Internet 402). The service voucher device 300 is also accessed to a service provider network 401 operated by a service provider to provide service support related to the service. Implementations of using the service voucher check device 400 to authenticate the permission for using the target service are described in this embodiment.

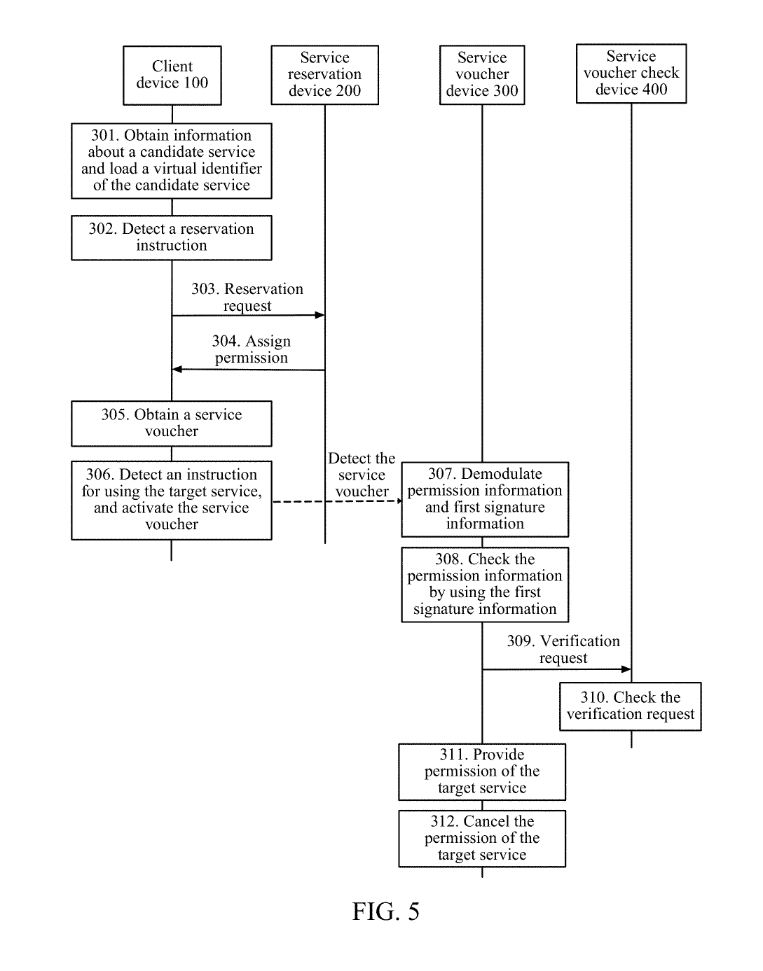

Referring to FIG. 5, this embodiment discloses a service voucher processing method, including the following steps:

Step 301: A client device 100 obtains information about a candidate service and loads a virtual identifier of the candidate service in a graphical interface.

Step 302: The client device 100 detects a reservation instruction for the candidate service based on the virtual identifier.

Step 303: The client device 100 detects a target service reserved by the reservation instruction in the candidate service and initiates a reservation request for the target service to a service reservation device 200.

Step 304: The service reservation device 200 assigns permission corresponding to the target service.

Step 305: The client device 100 obtains a service voucher corresponding to the target service based on the permission corresponding to the target service.

The service voucher may be correspondingly generated by the service reservation device 200 based on the permission assigned to the client device 100, or may be generated by the client device 100 based on the assigned permission corresponding to the target service.

Step 306: The client device 100 detects an instruction for using the target service, and activates the service voucher of the target service.

Descriptions of step 301 to step 306 are implemented with reference to the foregoing disclosure of embodiment 1, and details are not described herein again.

Subsequent steps are that the service voucher device 300 performs, based on the detected activated service voucher, authentication on the permission for using the target service.

Step 307: The service voucher device 300 demodulates permission information and first signature information from the service voucher.

Step 308: The service voucher device 300 checks the permission information by using the first signature information.

A public key of an asymmetric encryption algorithm is used for decrypting the first signature information to obtain an abstract of the permission information, and the abstract of the permission information is extracted (for example, a hash value is extracted by using a hash algorithm). The abstract obtained by decrypting the first signature information is compared with the abstract extracted from the permission information. If the abstract obtained by decrypting the first signature information and the abstract extracted from the permission information are consistent, checking passes, and subsequently continue to perform step 309; if the abstract obtained by decrypting the first signature information and the abstract extracted from the permission information are inconsistent, it indicates that a source of the permission information is not reliable, and stop the processing.

Step 309: The service voucher device 300 initiates, by using a communications network (such as the Internet), a verification request carrying the permission information to the service voucher check device 400.

The verification request carries second signature information, and the second signature information is obtained by encrypting an abstract of the verification request by using a private key of the asymmetric encryption algorithm. The abstract of the verification request may be extracted from the verification request by using the hash algorithm.

Step 310: The service voucher check device 400 checks the verification request.

The service voucher check device 400 triggers the following processing: comparing the permission information carried in the verification request with the permission information of the assigned permission; if the permission information carried in the verification request and the permission information of the assigned permission are consistent, determining that the authentication on the permission for using the target service passes; and if the permission information carried in the verification request and the permission information of the assigned permission are inconsistent, determining that the authentication on the permission for using the target service does not pass.

Step 311: The service voucher device 300 provides the permission of the target service when determining that the authentication performed by the service voucher check device 400 on the permission passes.

Step 312: The service voucher device 300 determines that the target service is used and cancels the permission of the target service.

The service voucher device 300 determines that the permission of the target service is used, and sends the permission information (including an identifier of a corresponding reservation request) of the used target service to the service reservation device 200, so that the service reservation device 200 cancels information of the assigned permission, thereby avoiding repeatedly assigning permission.

During actual application, out of security consideration, service voucher devices 300 of some service providers do not have network communication functions. If the foregoing disclosed solution in embodiment 2 is implemented, because of limitation of the network communication function of the service voucher device 300, a verification request cannot be initiated to the service voucher check device 400.

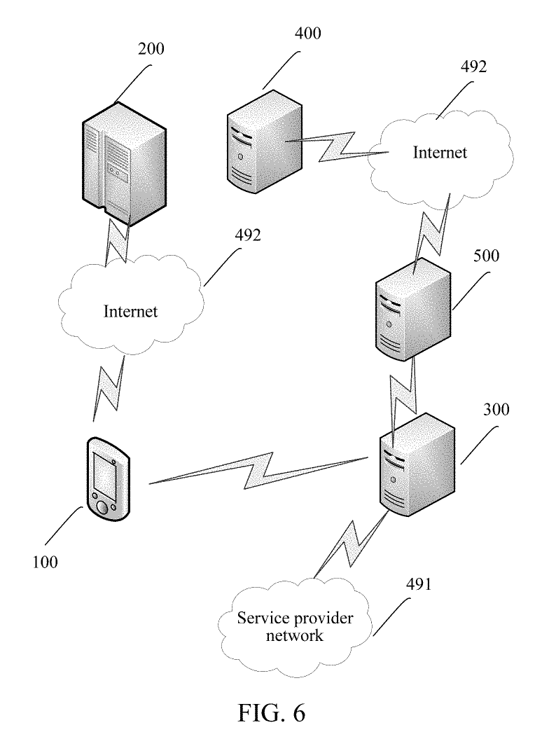

With respect to this problem, referring to FIG. 6 and based on FIG. 4, a service voucher processing system disclosed in this embodiment may further include a communications end device 500 (or a communications device 500 for short), configured to implement communication between the service voucher device 300 and the service voucher check device 400. A serial communication method is used between the service voucher device 300 and the communications device 500, and a cellular (2/3/4G) or WiFi communication method is used between the communications device 500 and the service voucher check device 400. In a physical relationship, the communications device 500 may be used as a device independent from the service voucher device 300, or may be used as a functional module to be coupled with the service voucher device 300 into a device.

Using an example in which the target service is a metro-taking service, the service voucher device 300 may be a ticket terminal in a metro system. Because of closure of the metro system, the ticket terminal does not have a network communication function. To enable the ticket system to support initiating of a verification request to the service voucher check device 400, a Linux development board (corresponding to the communications device 500) may be set in the ticket terminal based on an ARM (Acorn RISC Machine). A serial communication method is used between the Linux development board and the ticket terminal, and a cellular or WiFi communication method is used between the Linux development board and the service voucher check device 400, thereby not only supporting the network communication between the ticket terminal and the service voucher check device 400, but also avoiding a risk of infecting viruses by the ticket terminal.

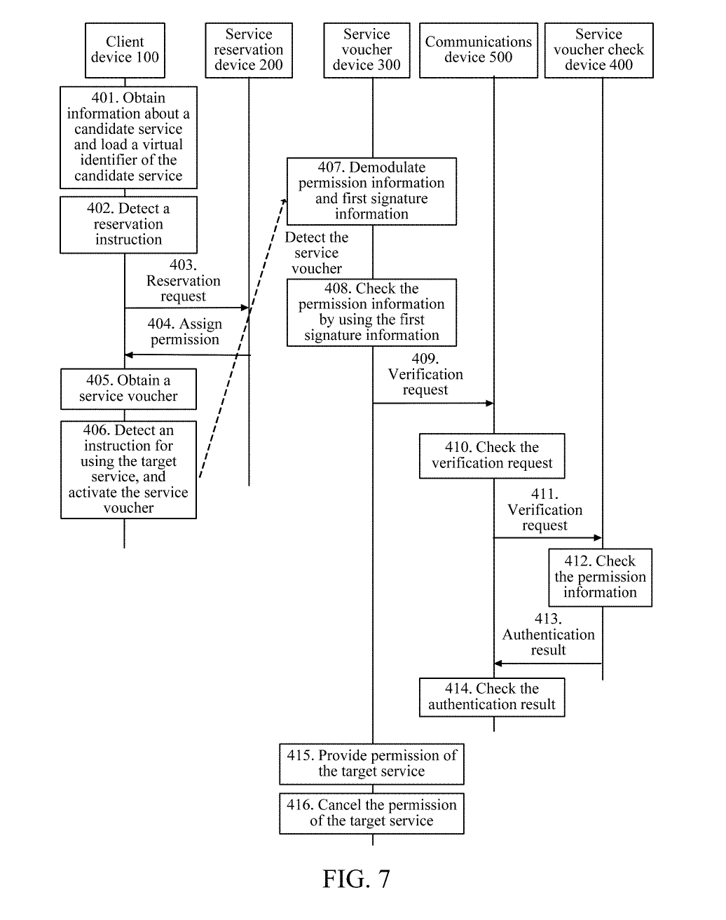

Referring to FIG. 7, when a communications device 500 is set in a service voucher processing system, service voucher processing includes the following steps:

Step 401: A client device 100 obtains information about a candidate service and loads a virtual identifier of the candidate service in a graphical interface.

Step 402: The client device 100 detects a reservation instruction for the candidate service based on the virtual identifier.

Step 403: The client device 100 detects a target service reserved by the reservation instruction in the candidate service and initiates a reservation request for the target service to a service reservation device 200.

Step 404: The service reservation device 200 assigns permission corresponding to the target service.

Step 405: The client device 100 obtains a service voucher corresponding to the target service based on the permission corresponding to the target service.

The service voucher may be correspondingly generated by the service reservation device 200 based on the permission assigned to the client device 100, or may be generated by the client device 100 based on the assigned permission corresponding to the target service.

Step 406: The client device 100 detects an instruction for using the target service, and activates the service voucher of the target service.

Refer to the foregoing disclosure of embodiment 1 for descriptions of step 401 to step 406, and details are not described herein again.

Subsequent steps are that the service voucher device 300 performs, based on the detected activated service voucher, authentication on the permission for using the target service.

Step 407: The service voucher device 300 demodulates permission information and first signature information from the service voucher.

Step 408: The service voucher device 300 checks the permission information by using the first signature information.

A public key of an asymmetric encryption algorithm is used for decrypting the first signature information to obtain an abstract of the permission information, and the abstract of the permission information is extracted (for example, a hash value is extracted by using a hash algorithm). The abstract obtained by decrypting the first signature information is compared with the abstract extracted from the permission information. If the abstract obtained by decrypting the first signature information and the abstract extracted from the permission information are consistent, checking passes, and subsequently continue to perform step 403; if the abstract obtained by decrypting the first signature information and the abstract extracted from the permission information are inconsistent, it indicates that a source of the permission information is not reliable, and stop the processing.

Step 409: The service voucher device 300 sends a verification request carrying the permission information to a communications device 500 through a communication channel, the verification request carrying second signature information. The communication chancel may be a serial port, so that to avoid virus infection and ensure security.

The verification request carries second signature information, and the second signature information is obtained by encrypting an abstract of the verification request by using a private key of the asymmetric encryption algorithm. The abstract of the verification request may be extracted from the verification request by using the hash algorithm.

Step 410: The communications device 500 checks the verification request based on the second signature information.

A public key of an asymmetric encryption algorithm is used for decrypting the second signature information to obtain an abstract of the verification request, and the abstract of the verification request is extracted (for example, a hash value is extracted by using a hash algorithm). The abstract obtained by decrypting the second signature information is compared with the abstract extracted from the verification request. If the abstract obtained by decrypting the second signature information and the abstract extracted from the verification request are consistent, checking passes, and subsequently continue to perform step 411; if the abstract obtained by decrypting the second signature information and the abstract extracted from the verification request are inconsistent, it indicates that a source of the verification request is not reliable, and stop the processing.

Step 411: The communications device 500 initiates the verification request carrying the permission information to the service voucher check device 400 by using a communications network (such as a cellular communications network or a WiFi communications network).

Step 412: The service voucher check device 400 checks the permission information carried in the received verification request.

The service voucher check device 400 compares the permission information carried in the verification request with the permission information of the assigned permission; if the permission information carried by the verification request and the permission information of the assigned permission are consistent, determines that the authentication on the permission for using the target service passes; and if the permission information carried in the verification request and the permission information of the assigned permission are inconsistent, determines that the authentication on the permission for using the target service does not pass.

An authentication result sent by the service voucher check device 400 to the communications device 500 carries third signature information, and the third signature information is obtained by encrypting an abstract (the abstract of the authentication result may be obtained by calculating the authentication result by using the hash algorithm) of the authentication result by using a private key of the asymmetric encryption algorithm.

Step 413: The communications device 500 monitors the serial port and obtains an authentication result, sent by the service voucher check device 400, for the permission of the target service.

Step 414: The communications device 500 checks the authentication result based on the third signature information, and sends, by using the serial port, the authentication result to the service voucher device 300 when the checking passes.

The communications device 500 uses the public key of the asymmetric encryption algorithm to decrypt the third signature information to obtain an abstract of the authentication result, and extracts the abstract of the authentication result (for example, a hash value is extracted by using a hash algorithm). The abstract obtained by decrypting the third signature information is compared with the abstract extracted from the permission information. If the abstract obtained by decrypting the third signature information and the abstract extracted from the permission information are consistent, the checking passes, and subsequently continue to perform step 415; if the abstract obtained by decrypting the third signature information and the abstract extracted from the permission information are inconsistent, it indicates that a source of the permission information is not reliable, and stop the processing.

Step 415: The service voucher device 300 provides the permission of the target service when determining that the authentication result indicates that the authentication passes.

Step 416: The service voucher device 300 determines that the target service is used and cancels the permission of the target service.

The service voucher device 300 determines that the permission of the target service is used, and sends the permission information (including an identifier of a corresponding reservation request) of the used target service to the service reservation device 200, so that the service reservation device 200 cancels information of the assigned permission, thereby avoiding repeatedly assigning permission.

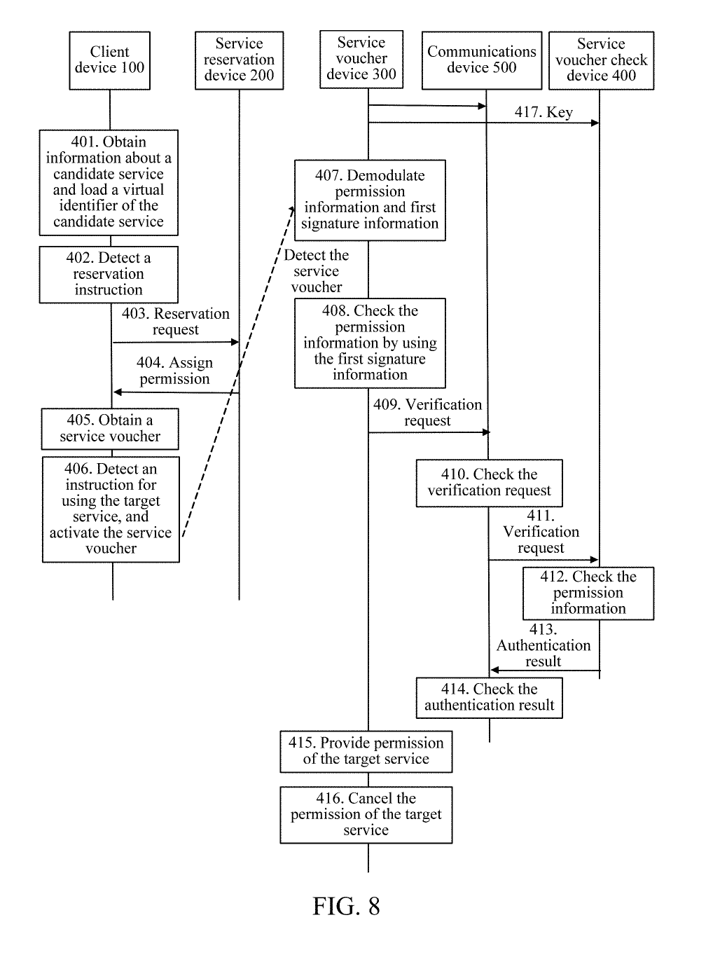

Referring to FIG. 8, based on FIG. 7, in step 417, the foregoing asymmetric encryption algorithm and keys (including the public key and the private key) of the asymmetric encryption algorithm are predetermined by the service voucher device 300, and the asymmetric encryption algorithm and the public key are distributed to the communications device 500 and the service voucher check device 400. The communications device 500 checks, based on the received asymmetric encryption algorithm and the public key, the verification request sent by the service voucher device 300 in foregoing step 410, and checks the authentication result sent by the service voucher check device 400 in step 414. The service voucher check device 400 performs signature on the sent authentication result (that is, carrying the third signature information in the authentication result), and the communications device 500 checks the authentication result based on the asymmetric encryption algorithm and the private key.

This embodiment discloses a scenario of independently networking at a service voucher check device. Because limitations of communication may exist at a service voucher device (for example, out of security consideration, a ticket fetching terminal in a metro system cannot directly communicate with the Internet), a communications device supports a data connection to the Internet by using wireless communication (such as cellular or WiFi). A serial communication method is used between the communications device and the service voucher device so as to implement brief communication between the service voucher device and the Internet, thereby facilitating engineering implementation, implementing network isolation, and fully blocking viruses and potential threats from external networks.

### Embodiment 3

Generally, a service provider provides a service for a fee. Therefore, when initiating a reservation request by using a client device 100, a user needs to pay necessary fees for using a target service. Moreover, a service voucher in the foregoing embodiments is in a form of an image, an acoustic signal, an optical signal, or a radio frequency signal. Actually, requirements for a service voucher (such as a paper bill) in a physical form may also exist. Therefore, a service voucher device 300 needs to support outputting of the service voucher in a physical form when permission of the target service is provided.

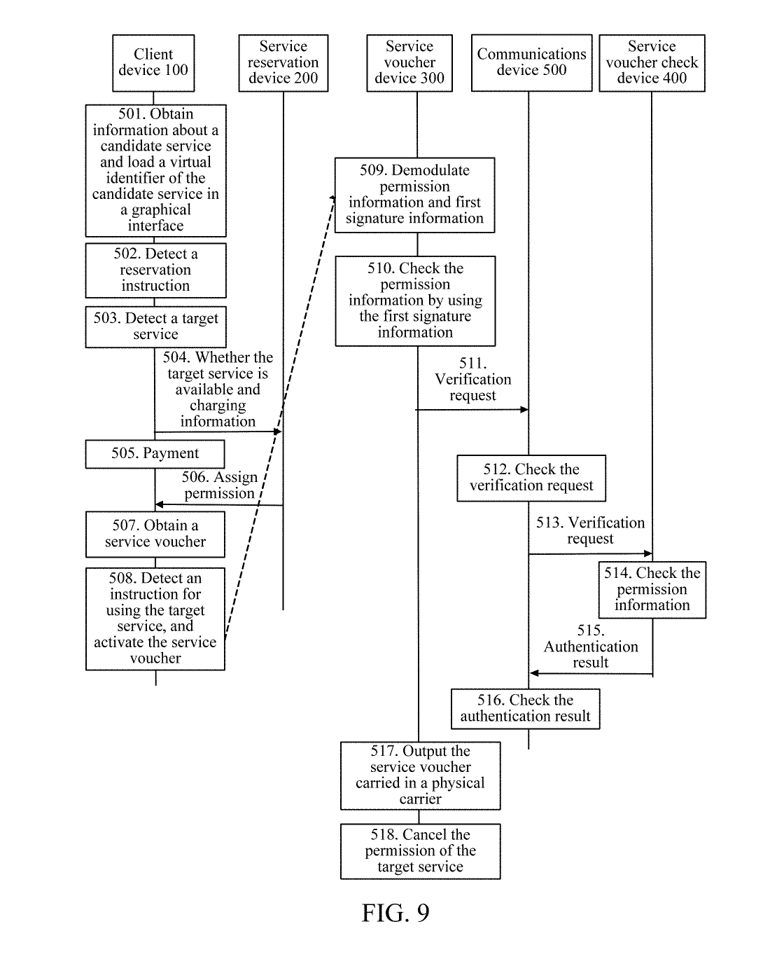

Referring to FIG. 9, a service voucher processing method disclosed in this embodiment includes the following steps:

Step 501: A client device 100 obtains information about a candidate service and loads a virtual identifier of the candidate service in a graphical interface.

Step 502: The client device 100 detects a reservation instruction for the candidate service based on the virtual identifier.

Step 503: The client device 100 detects a target service reserved by the reservation instruction in the candidate service.

Step 504: The client device 100 queries a service reservation device 200 for whether the target service is available and for charging information of the target service.

Step 505: The client device 100 determines that the target service is available, and loads, based on the charging information of the target service, a charging payment screen of a payment platform for the target service in the graphical interface, so as to support a payment operation for the target service.

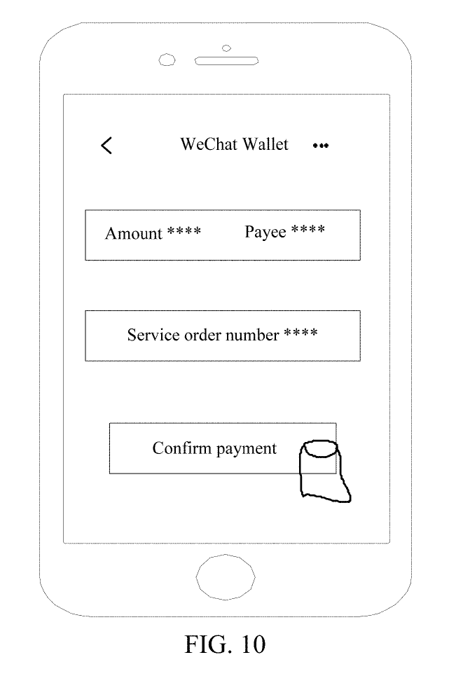

Referring to FIG. 10, the client device 100 operates a third party payment application that is preset by a user, and uses an account registered by the user on a payment platform of the third party payment application to complete the payment operation. The payment platform of the third party payment application may perform a transfer operation from a routine financial account (such as a credit card account or a debit card account) of the user, and the user does not need to deposit in advance on the payment platform of the third party payment application.

Step 506: The service reservation device 200 assigns permission corresponding to the target service.

Step 507: The client device 100 obtains a service voucher corresponding to the target service based on the permission corresponding to the target service.

The service voucher may be correspondingly generated by the service reservation device 200 based on the permission assigned to the client device 100, or may be generated by the client device 100 based on the assigned permission corresponding to the target service.

Step 508: The client device 100 detects an instruction for using the target service, and activates the service voucher of the target service.

Subsequent steps are that the service voucher device 300 performs, based on the detected activated service voucher, authentication on the permission for using the target service.

Step 509: The service voucher device 300 demodulates permission information and first signature information from the service voucher.

Step 510: The service voucher device 300 checks the permission information by using the first signature information.

A public key of an asymmetric encryption algorithm is used for decrypting the first signature information to obtain an abstract of the permission information, and the abstract of the permission information is extracted (for example, a hash value is extracted by using a hash algorithm). The abstract obtained by decrypting the first signature information is compared with the abstract extracted from the permission information. If the abstract obtained by decrypting the first signature information and the abstract extracted from the permission information are consistent, the checking passes, and subsequently continue to perform step 511; if the abstract obtained by decrypting the first signature information and the abstract extracted from the permission information are inconsistent, it indicates that a source of the permission information is not reliable, and stop the processing.

Step 511: The service voucher device 300 sends a verification request carrying the permission information to a communications device 500 by using a serial port, the verification request carrying second signature information.

The verification request carries second signature information, and the second signature information is obtained by encrypting an abstract of the verification request by using a private key of the asymmetric encryption algorithm. The abstract of the verification request may be extracted from the verification request by using the hash algorithm.

Step 512: The communications device 500 checks the verification request based on the second signature information.

A public key of an asymmetric encryption algorithm is used for decrypting the second signature information to obtain an abstract of the verification request, and the abstract of the verification request is extracted (for example, a hash value is extracted by using a hash algorithm). The abstract obtained by decrypting the second signature information is compared with the abstract extracted from the verification request. If the abstract obtained by decrypting the second signature information and the abstract extracted from the verification request are consistent, the checking passes, and subsequently continue to perform step 513; if the abstract obtained by decrypting the second signature information and the abstract extracted from the verification request are inconsistent, it indicates that a source of the verification request is not reliable, and stop the processing.

Step 513: The communications device 500 initiates the verification request carrying the permission information to the service voucher check device 400 by using a communications network (such as a cellular communications network or a WiFi communications network).

Step 514: The service voucher check device 400 checks the permission information carried in the received verification request.

The service voucher check device 400 compares the permission information carried in the verification request with the permission information of the assigned permission; if the permission information carried by the verification request and the permission information of the assigned permission are consistent, determines that the authentication on the permission for using the target service passes; and if the permission information carried in the verification request and the permission information of the assigned permission are inconsistent, determines that the authentication on the permission for using the target service does not pass.

An authentication result sent by the service voucher check device 400 to the communications device 500 carries third signature information, and the third signature information is obtained by encrypting an abstract (the abstract of the authentication result may be obtained by calculating the authentication result by using the hash algorithm) of the authentication result by using a private key of the asymmetric encryption algorithm.

Step 515: The communications device 500 monitors the serial port and obtains an authentication result, sent by the service voucher check device 400, for the permission of the target service.

Step 516: The communications device 500 checks the authentication result based on the third signature information, and sends, by using the serial port, the authentication result to the service voucher device 300 when the checking passes.

The communications device 500 uses the public key of the asymmetric encryption algorithm to decrypt the third signature information to obtain an abstract of the authentication result, and extracts the abstract of the authentication result (for example, a hash value is extracted by using a hash algorithm). The abstract obtained by decrypting the third signature information is compared with the abstract extracted from the permission information. If the abstract obtained by decrypting the third signature information and the abstract extracted from the permission information are consistent, the checking passes, and subsequently continue to perform step 517; if the abstract obtained by decrypting the third signature information and the abstract extracted from the permission information are inconsistent, it indicates that a source of the permission information is not reliable, and stop the processing.

Step 517: The service voucher device 300 determines that the authentication result indicates that the authentication passes, and outputs the service voucher carried in a physical carrier.

The physical carrier carries the service voucher of the target service by using one of the following methods:
1) an image; a printing device is included in the service voucher device 300, so as to output a service voucher in a form of a two-dimensional code, a barcode, or another form;
2) an acoustic signal; an acoustic wave generation apparatus may be included in the service voucher device 300 to support outputting of an acoustic signal (such as an ultrasonic signal), the acoustic signal carrying permission information of the target service;
3) an optical signal; an optical signal generation apparatus may be included in the service voucher device 300 to support outputting of an optical signal (such as an infrared signal), the optical signal carrying permission information of the target service; or
4) a radio frequency signal; a radio frequency generation apparatus may be included in the service voucher device 300 to support outputting of a radio frequency signal, the radio frequency signal carrying permission information of the target service.

Step 518: The service voucher device 300 determines that the target service is used and cancels the permission of the target service.

### Embodiment 4

The technical solutions disclosed by the foregoing embodiments are further described in this embodiment by using a metro-taking service as an example.

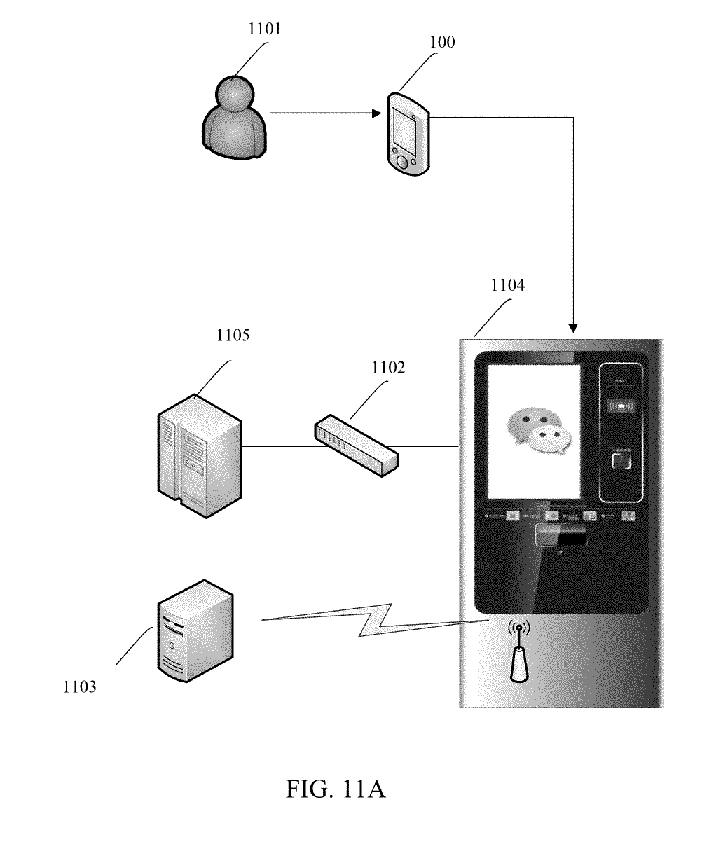

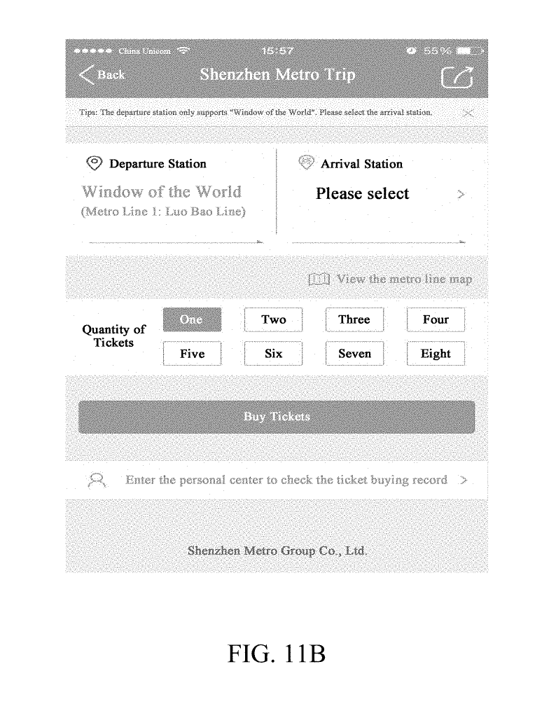

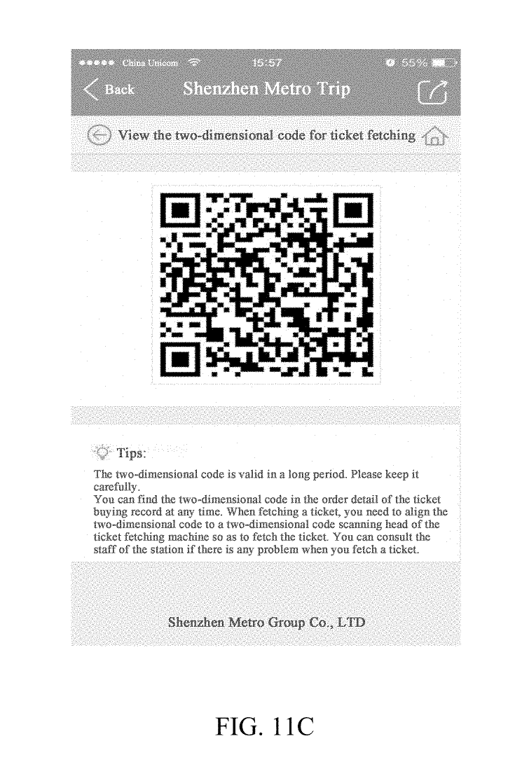

Referring to FIG. 11A, a user 1101 logins a metro online ticket ordering page by using a client device 100, selects a ticket on a ticket purchasing page shown in FIG. 11B, and obtains a two-dimensional code ticket, the two-dimensional code ticket including information such as an order, stations, a quantity of tickets, an amount of money, and a signature.

The user 1101 redeems a physical ticket on a ticket fetching machine 1104 by using the two-dimensional code ticket shown in FIG. 11C. The ticket fetching machine 1104 scans the two-dimensional code to perform signature check on the voucher. After verifying that the ticket is valid, the ticket fetching machine 1104 outputs the physical ticket, and, by accessing the Internet by using a Linux development board that is included in the ticket fetching machine 1104, communicates a ticket redemption check system 1103 to perform authentication and cancellation.

The ticket fetching machine 1104 is accessed to the Internet by using the Linux development board, and is connected to an intra-station computer system 1105 of the metro by using a switch 1102. Therefore, the intra-station computer system 1105 is separated (cannot be accessed) from the Internet, thereby, on one hand, supporting an online ticket ordering service, and on the other hand, avoiding potential risks caused by accessing all the metro system (including the intra-station computer system 1105) to the Internet because the ticket fetching machine 1104 needs to access to the Internet for cancelling the two-dimensional code ticket.

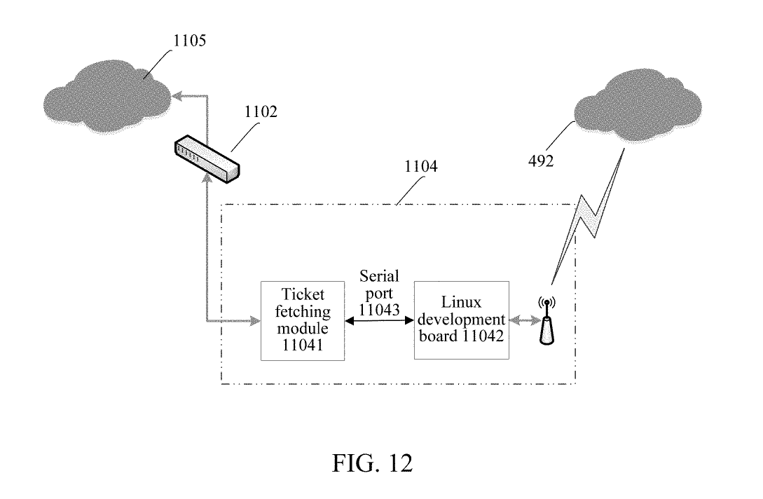

Referring to FIG. 12, an online ticket fetching module 11041 (a service voucher check device) in the ticket fetching machine 1104 is connected to a metro network, that is, the intra-station computer system 1105. Because of closure of the metro network (a service provider network), that is, because of closure of the intra-station computer system 1105, the ticket fetching module 11041 cannot be directly accessed to the Internet for communication, but is accessed to the Internet 492 by using a Linux development board 11042 in the online ticket fetching machine 1104. A serial port 11043 is used for communication between the ticket fetching module 11041 and the Linux development board 11042 so as to avoid virus infection and ensure security of the metro network. The Linux development board 11042 is accessed to the Internet 492 by using cellular/WiFi to communicate with the ticket redemption check system 1103 (the service voucher check device).

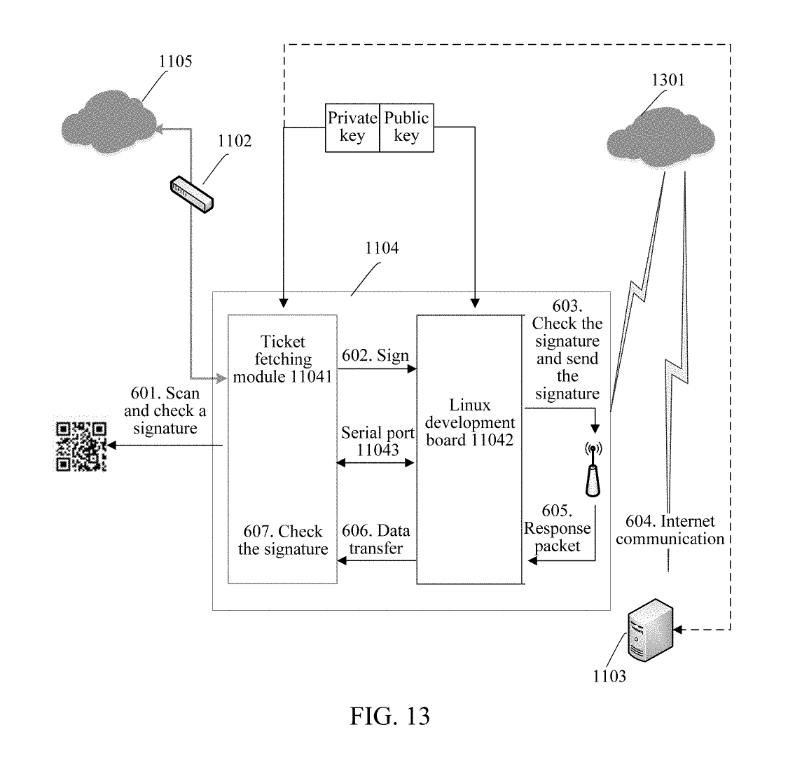

Referring to FIG. 13, the user reserves a bus/metro/train/ taking service by using a client device, and receives a two-dimensional code (a service voucher) delivered by a ticket ordering system (a service voucher reservation end). When the user needs to redeem a ticket on the ticket fetching machine 1104 to take the bus/metro/train, the client device displays the two-dimensional code for the ticket fetching machine to scan and check signature information (step 601). After checking of the signature information passes, the ticket fetching module 11041 constructs a packet of a ticket redemption request, signs by using a private key, and sends the packet to the Linux development board 11042 by using a serial port 11043 (step 602). The Linux development board monitors the serial port 11043, receives data sent by the ticket fetching module 11041, and checks a signature by using a public key. After the check succeeds, the packet of the ticket redemption request is sent to the ticket redemption check system by means of the Internet by using an encrypted Hypertext Transfer Protocol (HTTPS) by using a wireless network 1301 (step 603). The Linux development board 11042 receives a response packet from the ticket redemption check system 1103 (step 605). The Linux development board 11042 transfers the response packet to the ticket fetching module 11041 by using the serial port 11043 (step 606). The ticket fetching module 11041 performs signature check by using the public key, and outputs a physical ticket voucher after the check passes (step 607).

### Embodiment 5

This embodiment discloses a service voucher processing system, referring to FIG. 1, including:
a client device 100, configured to obtain information about a candidate service, load a virtual identifier of the candidate service in a graphical interface based on the information about the candidate service, and detect a reservation instruction for the candidate service based on the virtual identifier;
the client device 100, further configured to initiate, if a target service reserved by the reservation instruction in the candidate service is detected, a reservation request for the target service;
a service reservation device 200, configured to assign permission corresponding to the target service;
the client device 100, further configured to obtain a service voucher corresponding to the target service based on the permission corresponding to the target service, and activate the service voucher of the target service if an instruction for using the target service is detected; and
a service voucher device 300, configured to perform, based on the detected activated service voucher, authentication on the permission for using the target service, provide the permission of the target service if it is determined that the authentication passes, determine that the target service is used, and cancel the permission of the target service, a verification request carrying permission information being initiated in an authentication process, and a serial communication method being used for the verification request.

The client device 100 is further configured to obtain the permission information of the target service and first signature information corresponding to the permission information, the permission information including at least an identifier of the reservation request and the first signature information, encode the permission information and the first signature information, and modulate information obtained from encoding into at least one of the following to obtain the service voucher: an image, an acoustic signal, an optical signal, or a radio frequency signal.

Referring to FIG. 4, the service voucher processing system further includes a service voucher check device 400;
the service voucher device 300 is further configured to demodulate the permission information and the first signature information from the service voucher, check the permission information by using the first signature information, and initiate the verification request carrying the permission information to the service voucher check device 400, the verification request further carrying second signature information; and
the service voucher check device 400 is configured to check the verification request based on the second signature information; compare the permission information carried by the verification request with the permission information of the assigned permission; if the permission information carried by the verification request and the permission information of the assigned permission are consistent, determine that the authentication on the permission for using the target service passes; and if the permission information carried by the verification request and the permission information of the assigned permission are inconsistent, determine that the authentication on the permission for using the target service does not pass.

Referring to FIG. 6, the service voucher processing system further includes a communications device 500; and
the service voucher device 300 is further configured to send the verification request carrying the permission information to the communications device 500 by using a serial port of the service voucher device 300, so as to enable the communications device 500 to check the verification request based on the second signature information, and initiate the verification request carrying the permission information by using a communications network.

the service voucher device 300 is further configured to monitor the serial port of the service voucher device 300 and obtain an authentication result that is sent by the communications device 500 and that is for the permission of the target service, the authentication result carrying third signature information, check the authentication result based on the third signature information, and determine that the authentication result indicates that the authentication passes.

The service voucher device 300 is further configured to pre-distribute an asymmetric encryption algorithm, and key pair information of the asymmetric encryption algorithm; and
the asymmetric encryption algorithm and private key information in the key pair are used for processing an abstract of to-be-sent information to generate corresponding signature information, and a public key in the key pair is used for decrypting the signature information in the received information to obtain the abstract, so as to verify reliability of the received information.

The service voucher device 300 is further configured to output the service voucher carried in a physical carrier, the physical carrier carrying the service voucher of the target service by using one of the following methods: an image, an acoustic signal, an optical signal, or a radio frequency signal.

The client device 100 is further configured to query whether the target service is available and for charging information of the target service, determine that the target service is available, and load, based on the charging information of the target service, a charging payment screen of a payment platform for the target service in the graphical interface, so as to support a payment operation for the target service.

### Embodiment 6

This embodiment provides a client device, the client device including:
an obtaining unit, configured to obtain information about a candidate service, load a virtual identifier of the candidate service in a graphical interface based on the information about the candidate service, and detect a reservation instruction for the candidate service based on the virtual identifier;
a detection unit, configured to initiate, if a target service reserved by the reservation instruction in the candidate service is detected, a reservation request for the target service, so as to obtain permission corresponding to the target service; and
a service voucher processing unit, configured to obtain a service voucher corresponding to the target service based on the permission corresponding to the target service, and activate the service voucher of the target service if an instruction for using the target service is detected,
the service voucher being used for triggering a process of authenticating the permission for using the target service, so as to provide the permission of the target service when the authentication passes, and a serial communication method being used for a verification request that carries permission information and that is initiated in the authentication process.

This embodiment provides a client device, the client device including:
a storage medium, configured to store a computer executable instruction; and
a processor, configured to execute the computer executable instruction stored on the storage medium, the computer executable instruction comprising:
obtaining information about a candidate service, loading a virtual identifier of the candidate service in a graphical interface based on the information about the candidate service, and detecting a reservation instruction for the candidate service based on the virtual identifier;
initiating, if a target service reserved by the reservation instruction in the candidate service is detected, a reservation request for the target service, so as to obtain permission corresponding to the target service; and
obtaining a service voucher corresponding to the target service based on the permission corresponding to the target service, and activating the service voucher of the target service if an instruction for using the target service is detected,
the service voucher being used for triggering a process of authenticating the permission for using the target service, so as to provide the permission of the target service when the authentication passes, and a serial communication method being used for a verification request that carries permission information and that is initiated in the authentication process.

This embodiment of the present invention provides a service voucher device, the service voucher device including:
an assignment unit, configured to assign permission of a target service reserved by a corresponding client device by using a reservation request; and
an authentication unit, configured to perform, based on a detected activated service voucher, authentication on the permission for using the target service;
provide the permission of the target service if it is determined that the authentication passes, determine that the target service is used, and cancel the permission of the target service, a verification request carrying permission information being initiated in an authentication process, and a serial communication method being used for the verification request.

This embodiment provides a service voucher device, the service voucher device including:
a storage medium, configured to store a computer executable instruction; and
a processor, configured to execute the computer executable instruction stored on the storage medium, the computer executable instruction comprising:
assigning permission of a target service reserved by a corresponding client device by using a reservation request;
performing, based on a detected activated service voucher, authentication on the permission for using the target service;
provide the permission of the target service if it is determined that the authentication passes, determine that the target service is used, and cancel the permission of the target service, a verification request carrying permission information being initiated in an authentication process, and a serial communication method being used for the verification request.

In this embodiment, units in the client device and the service voucher device may be implemented by processors in corresponding devices, or certainly, may be implemented by a microprocessor (MPU), a digital signal processor (DSP), or a field programmable gate array (FPGA).

This embodiment further discloses a computer readable medium, which may be an ROM (such as a Read-Only Memory, a FLASH memory, or a transfer apparatus), a magnetic storage medium (such as a magnetic tape or a disk drive), an optical storage medium (such as a CD-ROM, a DVD-ROM, a punch card, or a tape), or program storage devices of other well-known types. The computer readable medium stores a computer executable instruction, used for performing the service voucher processing method provided in this embodiment of the present invention.

In conclusion, based on the technical solutions disclosed in the embodiments of the present invention, when a user needs to use a target service, the user initiates a reservation request for the target service to a service reservation device by using a client device (during actual implementation, the reservation request may be sent after payment for the target service is completed), so that a service voucher required for using the target service may be assigned to a service reservation system (the service voucher is different from an IC card; for example, the service voucher may be in a form of an image such as a two-dimensional code, thereby saving cost of setting the IC card in the client device). That is, based on a service voucher processing system shown in FIG. 1, for the user, as long as the client device of the user has a communications capability (such as cellular communication or WiFi communication) and can send the reservation request to the service reservation device, the client device may obtain, in any time at any place according to own requirements, a service voucher of a service (a target service) required to be used, and use the service based on the service voucher.

The user may complete the target service by using a payment platform of a third party application without implementing an IC card in the client device and without prepaying, thereby greatly facilitating the user to reserve and use the service.

The user may use physical vouchers in various forms, and the user can use the physical vouchers in different occasions after permission for the target service is assigned to the physical vouchers.

A person of ordinary skilled in the art may understand that all or some of the steps of the method embodiments may be implemented by a program instructing relevant hardware. The program may be stored in a computer-readable storage medium. When the program runs, the steps of the method embodiments are performed. The foregoing storage medium includes: any medium that can store program code, such as a removable storage device, a random access memory (RAM, Random Access Memory), a read-only memory (ROM, Read-Only Memory), a magnetic disk, or an optical disc.

Alternatively, when the integrated unit of the present invention is implemented in the form of a software functional module and sold or used as an independent product, the integrated unit may be stored in a computer-readable storage medium. Based on such an understanding, the technical solutions of this embodiment of the present invention essentially, or the part contributing to the relevant technology may be implemented in a form of a software product. The software product is stored in a storage medium including non-transitory storage medium, and includes several instructions for instructing a computer device (which may be a personal computer, a server, or a network device) to perform all or some of the methods described in the embodiments of the present invention. The foregoing storage medium includes: any medium that can store program code, such as a removable storage device, an RAM, an ROM, a magnetic disk, or an optical disc.

The foregoing descriptions are merely specific implementation manners of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

What is claimed is:

1. A service voucher processing system, comprising:
a service reservation device, configured to assign permission corresponding to a target service detected by a client device, wherein the client device is configured to:
obtain information about a candidate service,
load a virtual identifier of the candidate service in a graphical interface based on the information about the candidate service,
detect a reservation instruction for the candidate service based on the virtual identifier,
when the target service reserved by the reservation instruction in the candidate service is detected, initiate a reservation request for the target service,
obtain a service voucher corresponding to the target service based on the permission corresponding to the target service, and
when an instruction for using the target service is detected, activate the service voucher of the target service; and
a service voucher device, configured to:
perform, based on the activated service voucher, authentication on the permission corresponding to the target service,
when it is determined that the authentication passes, provide the permission corresponding to the target service,
when it is determined that the target service is used, cancel the permission corresponding to the target service, and
wherein a verification request carrying permission information of the target service is initiated in an authentication process and a serial communication method is used for the verification request.

2. The service voucher processing system according to claim 1, wherein the client device is further configured to:
obtain the permission information of the target service and first signature information corresponding to the permission information, the permission information comprising at least an identifier of the reservation request and the first signature information;
encode the permission information and the first signature information to obtain information; and
modulate the information obtained from encoding into at least one of the following forms to obtain the service voucher:
an image,
an acoustic signal,
an optical signal, or
a radio frequency signal.

3. The service voucher processing system according to claim 2, wherein:
the service voucher processing system further comprises a a service voucher check device; the service voucher device is further configured to:
demodulate the permission information and the first signature information from the service voucher,
check the permission information by using the first signature information, and
initiate the verification request carrying the permission information to the service voucher check device, the verification request further carrying second signature information; and
the service voucher check device is configured to:
check the verification request based on the second signature information,
compare the permission information carried in the verification request with the permission information of the assigned permission,
when it is determined that the permission information carried in the verification request and the permission information of the assigned permission are consistent, determine that the authentication on the permission for using the target service passes, and
when the permission information carried in the verification request and the permission information of the assigned permission are inconsistent, determine that the authentication on the permission for using the target service does not pass.

4. The service voucher processing system according to claim 3, wherein
the service voucher processing system further comprises a communications device; and
the service voucher device is further configured to send the verification request carrying the permission information to the communications device by using a serial port of the service voucher device, so as to enable the communications device to:
check the verification request based on the second signature information, and
initiate the verification request carrying the permission information by using a communications network.

5. The service voucher processing system according to claim 4, wherein the service voucher device is further configured to:
monitor the serial port of the service voucher device;
obtain an authentication result sent by the communications device and for the permission corresponding to the target service, the authentication result carrying third signature information; and
check the authentication result based on the third signature information; to determine whether the authentication passes.

6. The service voucher processing system according to claim 2, wherein
the service voucher device is further configured to pre-distribute an asymmetric encryption algorithm and key pair information of the asymmetric encryption algorithm, wherein
the asymmetric encryption algorithm and private key information in the key pair information are used for processing an abstract of to-be-sent information to generate corresponding signature information, and
a public key in the key pair information is used for decrypting the corresponding signature information in received information to obtain the abstract of the to-be-sent information, so as to verify reliability of the received information.

7. The service voucher processing system according to claim 1, wherein the service voucher device is further configured to output the service voucher in a physical carrier, the physical carrier carrying the service voucher of the target service by using one of the following methods:
an image,
an acoustic signal,
an optical signal, or
a radio frequency signal.

8. A service voucher processing method, comprising:
obtaining, by a client device comprising a first memory and a first processor in communication with the first memory, information about a candidate service, loading a virtual identifier of the candidate service in a graphical interface based on the information about the candidate service, and detecting a reservation instruction for the candidate service based on the virtual identifier;
initiating, by the client device, when a target service reserved by the reservation instruction in the candidate service is detected, a reservation request for the target service, so as to trigger a service reservation device to assign permission corresponding to the target service, the service reservation device comprising a second memory and a second processor in communication with the second memory;
obtaining, by the client device, a service voucher corresponding to the target service based on the permission corresponding to the target service;
activating, by the client device, the service voucher of the target service when an instruction for using the target service is detected;
performing, by a service voucher device comprising a third memory and a third processor in communication with the third memory, based on the activated service voucher, authentication on the permission for using the target service, a verification request carrying permission information being initiated in an authentication process, and a serial communication method being used for the verification request; and
providing, by the service voucher device, the permission of the target service if it is determined that the authentication passes, determining that the target service is used, and cancelling the permission of the target service.

9. The service voucher processing method according to claim 8, wherein the obtaining a service voucher corresponding to the target service based on the permission of the target service comprises:
obtaining, by the client device, the permission information of the target service and first signature information corresponding to the permission information, the permission information comprising at least an identifier of the reservation request; and
encoding, by the client device, the permission information and the first signature information corresponding to the permission information, so as to obtain the service voucher in at least one of the following forms:
an image,
an acoustic signal,
an optical signal, or
a radio frequency signal.

10. The service voucher processing method according to claim 9, wherein the performing, based on the activated service voucher, authentication on the permission for using the target service comprises:
demodulating, by the service voucher device, the permission information and the first signature information from the service voucher;
checking, by the service voucher device, the permission information by using the first signature information;
initiating, by the service voucher device, the verification request carrying the permission information, the verification request carrying second signature information;
checking, by a service voucher check device comprising a fourth memory and a fourth processor in communication with the fourth memory, the verification request based on the second signature information;
comparing, by the service voucher check device, the permission information carried in the verification request with the permission information of the assigned permission;
when the permission information carried in the verification request and the permission information of the assigned permission are consistent, determining, by the service voucher check device, that the authentication on the permission for using the target service passes; and
when the permission information carried in the verification request and the permission information of the assigned permission are inconsistent, determining, by the service voucher check device, that the authentication on the permission for using the target service does not pass.

11. The service voucher processing method according to claim 10, wherein the initiating the verification request carrying the permission information comprises:
sending, by the service voucher device, the verification request carrying the permission information to a communications device by using a serial port, so as to enable the communications device to check the verification request based on the second signature information, the communications device comprising a fifth memory and fifth processor in communication with the fifth memory; and
initiating, by the communications device, the verification request carrying the permission information by using a communications network.

12. The service voucher processing method according to claim 11, wherein the determining that the authentication passes comprises:
monitoring, by the service voucher device, the serial port and obtaining an authentication result for the permission of the target service, the authentication result carrying third signature information;
checking, by the service voucher device, the authentication result based on the third signature information; and
determining, by the service voucher device, that the authentication result indicates that the authentication passes.

13. The service voucher processing method according to claim 9, further comprising:
pre-distributing, by the service voucher device, an asymmetric encryption algorithm, and key pair information of the asymmetric encryption algorithm, wherein:
the asymmetric encryption algorithm and private key information in the key pair information are used for processing an abstract of to-be-sent information to generate corresponding signature information, and
a public key in the key pair information is used for decrypting the corresponding signature information in received information to obtain the abstract of the to-be-sent information, so as to verify reliability of the received information.

14. The service voucher processing method according to claim 8, wherein the providing the permission of the target service comprises:
outputting, by the service voucher device, the service voucher in a physical carrier, the physical carrier carrying the service voucher of the target service by using one of the following methods:
an image,
an acoustic signal,
an optical signal, or
a radio frequency signal.

15. A service voucher processing method, comprising:
obtaining, by a client device comprising a memory and a processor in communication with the memory, information about a candidate service, loading a virtual identifier of the candidate service in a graphical interface based on the information about the candidate service, and detecting a reservation instruction for the candidate service based on the virtual identifier;
initiating, by the client device, when a target service reserved by the reservation instruction in the candidate service is detected, a reservation request for the target service, so as to obtain permission corresponding to the target service; and
obtaining, by the client device, a service voucher corresponding to the target service based on the permission corresponding to the target service, and activating the service voucher of the target service when an instruction for using the target service is detected, the service voucher being used for triggering a process of authenticating the permission for using the target service, so as to provide the permission of the target service when the authentication passes, and a serial communication method being used for a verification request that carries permission information and that is initiated in the authentication process.

16. A service voucher processing method, comprising:
assigning, by a service reservation device comprising a first memory and a first processor in communication with the first memory, permission of a target service reserved by a corresponding client by using a reservation request;
performing, based on a detected activated service voucher by a service voucher device comprising a second memory and a second processor in communication with the second memory, authentication on the permission for using the target service; and
providing, by the service voucher device, the permission of the target service when it is determined that the authentication passes, determining that the target service is used, and cancelling the permission of the target service, a verification request carrying permission information being initiated in an authentication process, and a serial communication method being used for the verification request.

17. A client device, comprising:
a memory storing instructions;
a processor in communication with the memory, wherein, when the processor executes the instructions, the processor is configured to cause the client device to:
obtain information about a candidate service, load a virtual identifier of the candidate service in a graphical interface based on the information about the candidate service, and detect a reservation instruction for the candidate service based on the virtual identifier;
initiate, if a target service reserved by the reservation instruction in the candidate service is detected, a reservation request for the target service, so as to obtain permission corresponding to the target service; and
obtain a service voucher corresponding to the target service based on the permission corresponding to the target service, and activate the service voucher of the target service if an instruction for using the target service is detected, the service voucher being used for triggering a process of authenticating the permission for using the target service, so as to provide the permission of the target service when the authentication passes, and a serial communication method being used for a verification request that carries permission information and that is initiated in the authentication process.

18. A service voucher device, comprising:
a memory storing instructions;
a processor in communication with the memory, wherein, when the processor executes the instructions, the processor is configured to cause the service voucher device to:
assign permission of a target service reserved by a corresponding client by using a reservation request; and
perform, based on a detected activated service voucher, authentication on the permission for using the target service;
provide the permission of the target service when it is determined that the authentication passes, determine that the target service is used, and cancel the permission of the target service, a verification request carrying permission information being initiated in an authentication process, and a serial communication method being used for the verification request.

19. A non-transitory computer readable storage medium storing computer readable instructions, the computer readable instructions, when executed by a processor, causing the processor to perform:
obtaining information about a candidate service, loading a virtual identifier of the candidate service in a graphical interface based on the information about the candidate service, and detecting a reservation instruction for the candidate service based on the virtual identifier;
initiating, when a target service reserved by the reservation instruction in the candidate service is detected, a reservation request for the target service, so as to trigger to assign permission corresponding to the target service;
obtaining a service voucher corresponding to the target service based on the permission corresponding to the target service;
activating the service voucher of the target service when an instruction for using the target service is detected;
performing, based on the activated service voucher, authentication on the permission for using the target service, a verification request carrying permission information being initiated in an authentication process, and a serial communication method being used for the verification request; and
providing the permission of the target service if it is determined that the authentication passes, determining that the target service is used, and cancelling the permission of the target service.

20. A non-transitory computer readable storage medium storing computer readable instructions, the computer readable instructions, when executed by a processor, causing the processor to perform:
obtaining information about a candidate service, loading a virtual identifier of the candidate service in a graphical interface based on the information about the candidate service, and detecting a reservation instruction for the candidate service based on the virtual identifier;
initiating, when a target service reserved by the reservation instruction in the candidate service is detected, a reservation request for the target service, so as to obtain permission corresponding to the target service; and
obtaining a service voucher corresponding to the target service based on the permission corresponding to the target service, and activating the service voucher of the target service when an instruction for using the target service is detected, the service voucher being used for triggering a process of authenticating the permission for using the target service, so as to provide the permission of the target service when the authentication passes, and a serial communication method being used for a verification request that carries permission information and that is initiated in the authentication process.

21. A non-transitory computer readable storage medium storing computer readable instructions, the computer readable instructions, when executed by a processor, causing the processor to perform:
assigning permission of a target service reserved by a corresponding client by using a reservation request;
performing, based on a detected activated service voucher, authentication on the permission for using the target service; and
providing the permission of the target service when it is determined that the authentication passes, determining that the target service is used, and cancelling the permission of the target service, a verification request carrying permission information being initiated in an authentication process, and a serial communication method being used for the verification request.
